(19) United States
(12) Patent Application Publication
(10) Pub. No.: US 2008/0132178 A1
(43) Pub. Date: Jun. 5, 2008

(54) Performing automatic frequency control

(76) Inventors: Shouri Chatterjee, New Delhi (IN); Aria Eshraghi, Austin, TX (US); John Khoury, Basking Ridge, NJ (US)

Correspondence Address: TROP PRUNER & HU, PC, 1616 S. VOSS ROAD, SUITE 750, HOUSTON, TX, 77057-2631, US

(21) Appl. No.: 11/901,775

(22) Filed: Sep. 19, 2007

Related U.S. Application Data
(60) Provisional application No. 60/846,609, filed on Sep. 22, 2006.

(51) Int. Cl. H04B 1/40

(52) U.S. Cl. 455/75

(57) ABSTRACT

Embodiments may be used to control a controllable element that has a nonlinear but monotonic relationship with a control value. In such embodiments, a system may perform control by receiving an error value corresponding to an error of an output signal from the controllable element, and determining the control value within two iterations of a Newton (Secant) algorithm, where the control value enables generation of the output signal within a predetermined tolerance to a nominal value for the control signal.

This application claims priority to U.S. Provisional Patent Application No. 60/846,609 filed on Sep. 22, 2006 in the name of Shouri Chatterjee, Aria Eshraghi and John Khoury, entitled PERFORMING AUTOMATIC FREQUENCY CONTROL.

### FIELD OF THE INVENTION

Embodiments of the present invention relate to controlling frequency in a system.

### BACKGROUND

In wireless systems, a reference clock is used in the modulation and demodulation of transmit and receive signals for GSM, EDGE, WCDMA and other cellular standards. Many systems use an oscillator to generate the reference clock. The initial frequency can be initially off by as much as +/−30 PPM due to crystal variations, IC variations and board capacitance variations. Accordingly, many systems implement a calibration procedure to try to reduce this error.

Even after such calibration, during operation the frequency can still drift as a result of temperature, aging or other conditions. Systems often include some type of automatic frequency control (AFC) in an effort to reduce this frequency error. However, such systems suffer from extensive complexity, power consumption, and computation inefficiencies.

### SUMMARY OF THE INVENTION

According to one aspect of the present invention, a method may be performed to converge a control value for controlling a controllable element to a desired tolerance in a relatively small number of algorithm iterations. In one such method, a frequency error value corresponding to an error of a reference clock may be received, and a control value for a capacitor array used to generate the reference clock may be determined within as few as two iterations of an algorithm. In this way, the control value may enable generation of the reference clock within a predetermined tolerance to a nominal value for the reference clock after execution of the method. If the control value and the reference clock frequency have a substantially linearized relationship rather than a linearized relationship, the control value may be determined in a number of iterations exceeding, but approaching two.

More generally, embodiments may be used to control a controllable element that has a nonlinear but monotonic relationship with a control value. In such embodiments, a system may perform control by receiving an error value corresponding to an error of an output signal from the controllable element, and determining the control value within two iterations of a Newton-Raphson algorithm, where the control value enables generation of the output signal within a predetermined tolerance to a nominal value for the control signal.

Yet another aspect of the present invention is directed to a system including a transceiver to transmit and receive radio frequency (RF) signals, where the transceiver includes an oscillator to generate a reference signal based on control of a controllable element of the transceiver. The system further includes a baseband processor coupled to the transceiver to provide a control signal to the transceiver to control a frequency of the reference signal, where the baseband processor includes a pre-distortion logic to receive a linearized control value determined according to a Newton iteration algorithm and to generate the control signal therefrom, where the pre-distortion logic is to apply the linearized control value to a predetermined function to predistort the linearized control value to linearize a relationship between the linearized control value and the reference signal frequency.

### BRIEF DESCRIPTION OF THE DRAWINGS

FIGS. 1A-1B are a flow diagram of a method in accordance with one embodiment of the present invention.

FIG. 2 is a block diagram of a general test environment in accordance with one embodiment of the present invention.

FIG. 3 is a flowchart of a calibration application in accordance with one embodiment of the present invention.

FIG. 4 is a block diagram of an AFC system in accordance with one embodiment of the present invention.

FIG. 5 is a graphical illustration of frequency error versus digital control value for various component variations.

FIG. 6 is a graphical illustration of frequency error versus linearized control value for various component variations.

FIG. 7 is a histogram of the number of iterations of an algorithm in accordance with an embodiment of the present invention to reduce a frequency error to less than ±0.3 PPM, when an initial error is up to ±30 PPM.

FIG. 8 is a histogram of initial frequency errors prior to automatic frequency control tuning.

FIG. 9 is a histogram of final frequency errors after fine frequency tuning in accordance with an embodiment of the present invention.

FIG. 10 is a histogram of final digital control word values after execution of an algorithm in accordance with an embodiment of the present invention.

FIG. 11 is a circuit diagram of a basic resonator model for a digitally controlled crystal oscillator.

FIG. 12 is a graphical illustration of an oscillator's frequency variation by capacitance change.

FIG. 13 is a graphical illustration of an error between exact and approximated estimates of capacitance changes.

FIG. 14 is a graphical illustration of capacitance as a function of alpha.

FIG. 15 is a graphical illustration of frequency change of a digitally controlled crystal oscillator as a function of alpha.

FIG. 16 is a graphical illustration of a comparison of an approximation of capacitance change versus exact capacitance change.

FIG. 17 is a graphical illustration of a digitally controlled crystal oscillator frequency as a function of input code with and without slope correction.

FIG. 18 is a graphical illustration of a digitally controlled crystal oscillator frequency as a function of change in M value.

FIG. 19 is a graphical illustration of a digitally controlled crystal oscillation frequency as a function of change in M value.

FIG. 20 is a graphical illustration of a slope of a digitally controlled crystal oscillator as a function of an input and output frequency of the oscillator.

FIG. 21 is a block diagram of a system in accordance with one embodiment of the present invention.

### DETAILED DESCRIPTION

In various embodiments, an algorithm may be used to perform frequency control for a reference clock. The algorithm may be used to linearize a non-linear transfer characteristic, such as a frequency change to a digital control signal. That is, in some implementations a wireless system may include an oscillator such as a digitally controlled crystal oscillator (DCXO). The DCXO may include one or more capacitor arrays that are controlled by the digital control signal, which may be a plurality of bits, N, used to control switching of the capacitors of the array to adjust frequency of the resulting reference clock.

In some implementations, the algorithm may apply a Newton Raphson iteration to a resulting linearized characteristic. The first step of the Newton iteration utilizes a nominal value for the slope of the frequency characteristic. The second step utilizes the actual slope, computed from the frequency error measurements obtained based on a reference clock generated using digital control signals generated from the linearized values to obtain a final control value for control of the DCXO that generates the reference clock in close tolerance to a threshold level (e.g., within less than ±0.3 ppm). Furthermore, implementations may be performed with a very rapid convergence rate, e.g., 2 or less iterations.

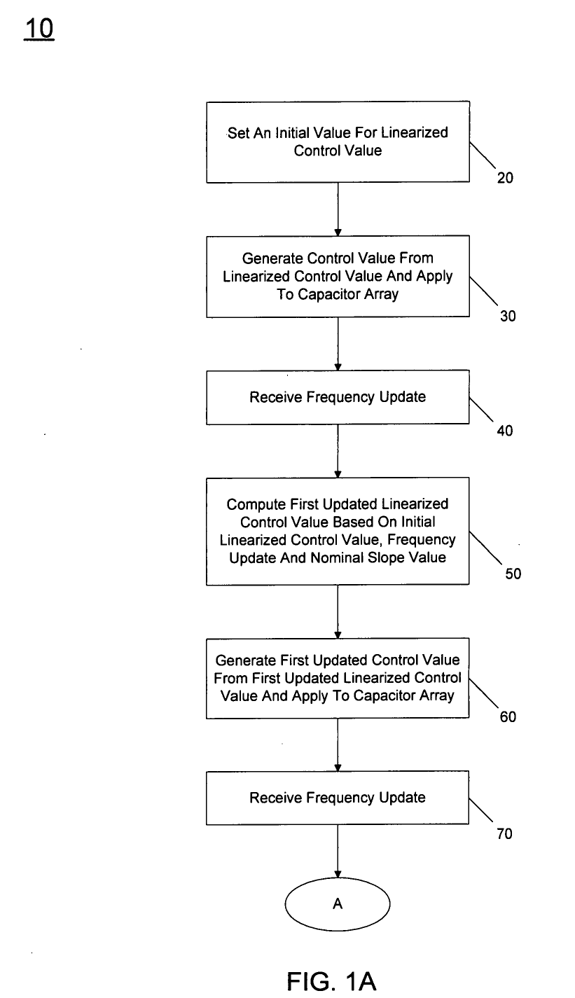

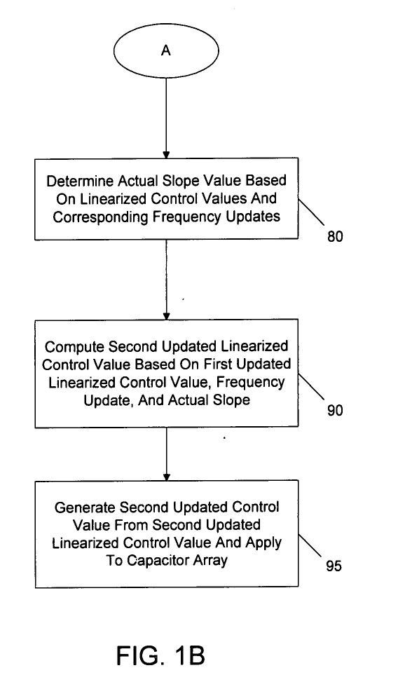

Referring now to FIGS. 1A-1B, shown is a flow diagram of a method in accordance with one embodiment of the present invention. As shown in FIG. 1A, method 10 may begin by setting an initial value for a linearized control value (block 20). This initial value, N′, may be a linearized representation of actual control bits, e.g., a digital control word N, that is used to control a capacitor array of the DCXO. In one embodiment, this linearized control value may be set at substantially a median level between a highest and lowest possible value. For example for a 13 bit control word, the value may be set at 4096, i.e., the mid point of the range.

Still referring to FIG. 1A, a control value may be generated from this linearized control value (block 30). For example, a function, e.g., g(N′), may be established such that for a given value of N′, a given value of N is obtained. Using this obtained value of N, the DCXO may be controlled accordingly (after the control value N is applied to the DCXO). Then a measurement of frequency error between the generated reference clock and a nominal or threshold reference clock can be made. In other words, a frequency update may be received corresponding to the generated reference clock that is used to generate an updated frequency error or frequency update (block 40).

Based on this frequency update, a first updated linearized control value may be computed (block 50). In one embodiment, this first updated linearized control value may be based on the initial linearized control value, the frequency update, and a nominal slope value. This nominal slope value may be a pre-computed slope value for a linearized frequency response corresponding to the linearized control value versus the frequency error information. From this first updated linearized control value, a first updated control value may be generated and used to control the capacitor array accordingly (block 60). At this generated frequency, another frequency update may be received (block 70). Then control passes to FIG. 1B, which is a continuation of method 10.

Thus a second error may be generated based on a frequency update. From this frequency error (if the frequency has not converged within a predetermined amount from the threshold reference frequency), next an actual slope value may be determined (block 80). This actual slope value may be based on the linearized control values previously determined and the frequency updates. That is, because a linearized response exists, these two points (each consisting of a frequency error value and a linearized control value) may be used to generate the actual slope.

Based on this actual slope, a second updated linearized control value may be computed (block 90). More specifically, in one embodiment this value may be based on the first updated linearized control value, the frequency update and the actual slope. Finally, based on this updated linearized control value, a second (and finalized) updated control value may be generated and used to control the DCXO (block 95). Owing to the efficiency of the algorithm, the reference clock should be within the desired tolerance of the threshold reference clock and thus efficient calibration can be realized within two iterations. While described with this particular implementation in the embodiment of FIGS. 1A and 1B, understand the scope of the present invention is not limited in this regard. For example, if the control value and the reference clock frequency do not have a linear relationship and instead have a substantially linear relationship, more iterations (but approaching two) may be needed, e.g., 3 or 4 iterations, although the scope of the present invention is not limited in this regard.

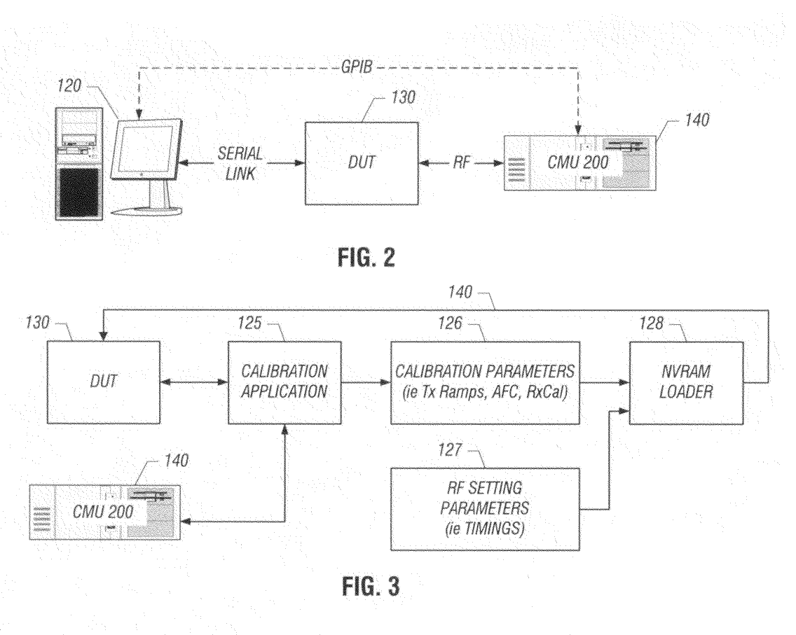

Referring now to FIG. 2, shown is a block diagram of a general test environment in accordance with one embodiment of the present invention. As shown in FIG. 2, the DUT 130 is connected to the PC 120 through a serial link and to a tester such as a GSM tester 140 (CMU200 from R&S by instance) by a RF link. Alternatively, the GSM tester can be also remote controlled by the Test Application through the GPIB link.

In the flowchart of FIG. 3, the Calibration Application 125 stores the calibration data into a file, which is subsequently downloaded to the DUT 130. Optionally, the Calibration Application 125 could directly download the parameters into the DUT 130 (it could invoke the NVRAM 128 loader by itself). This would avoid dealing manually with calibration files. NVRAM parameter names are in bold with brackets: [CDAC_VALUE].

A transceiver which is present in DUT 130 and which may be a handset or other wireless device, integrates the DCXO circuitry used to generate a precise system reference clock using only an external crystal resonator. The DCXO replaces the requirement for a discrete TC-VCXO module. The DCXO allows for the use of a standard 26 MHz crystal, which reduces both cost and area compared to using a TC-VCXO module. No external varactors or trim capacitors are required. This simplifies the design, programming, and manufacturing compared to less integrated solutions.

The DCXO uses the CDAC and CAFC arrays to correct for both static and dynamic frequency errors, respectively. An internal digitally programmable capacitor array (CDAC) provides a coarse method of adjusting the reference frequency in discrete steps. The CDAC[6:0] register can be programmed to compensate for static variations in PCB design, manufacturing, and crystal tolerance, and is typically set to center the oscillator frequency during IC production. A second capacitor array (CAFC) allows for fine and continuous dynamic adjustment of the reference frequency by a register setting. A baseband processor (herein baseband) determines the appropriate frequency adjustment based on the receipt of the FCCH burst. The baseband then adjusts the CAFC to correct the frequency errors. Based on typical variations expected in the PCB capacitance and crystal parameters, the CAFC capacitor array will be adequate to tune out all variations during the handset production and normal use. The CDAC array will be adjusted and held in on-chip NVRAM during IC production testing to center the DCXO with a nominal crystal and nominal PCB capacitances.

Different mechanisms may be used to perform frequency calibration. For example: the tester produces a fixed frequency signal (i.e. BCCH/FCH); and DUT transmits a signal and the tester measures the frequency error across 2 points.

We will not use any special calibration algorithm. Instead we will use the L1 Synchronization routine even in the factory calibration. In handset factory calibration, a preset [CDAC_VALUE], [AFC_VALUE], and [AFC_SLOPE] are loaded into the DUT. The tester produces a fixed frequency signal. The DUT measures the frequency error and stores [F_ERROR] in the NVRAM.

One global variable is used in the Layer1 context:
Sint16 frequencyOffset (In Hz)

For programming a transceiver in accordance with an embodiment of the present invention, four more variables may be used. These are cdacValue, afcDacValue, fError and afcDacSlope. These values are mapped to the [CDAC_VALUE], [AFC_VALUE], [F_ERROR] and [AFC_SLOPE] values stored in NVRAM. The assumption is that the RF Driver will have access to these NVRAM values. If the nominal [AFC_SLOPE] and [AFC_VALUE] values can be pre-coded in the RF Driver, then these default values need not be stored in the NVRAM.

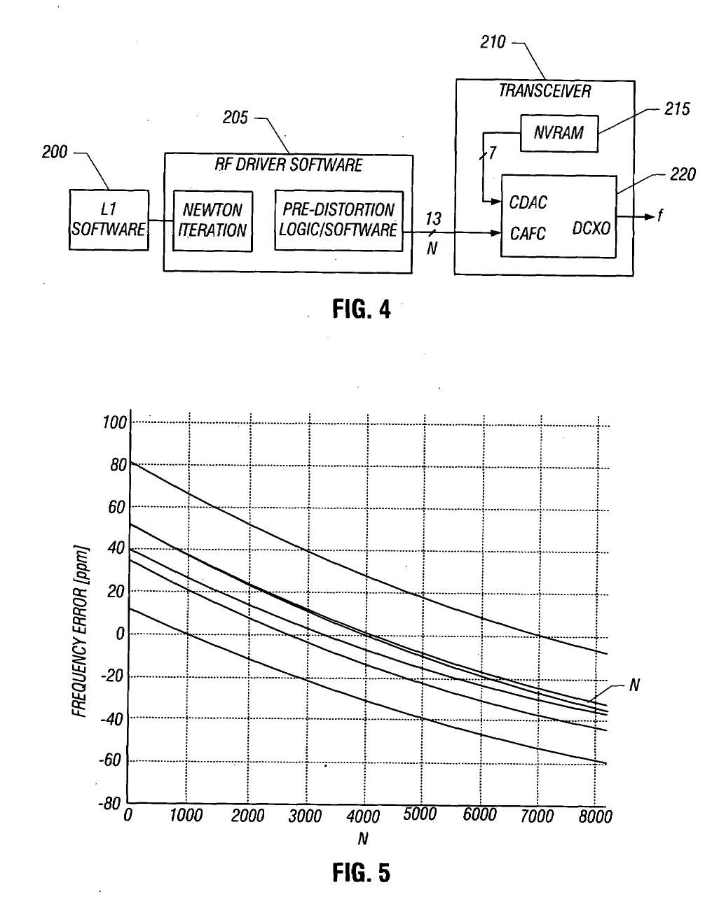

The block diagram of the AFC system is shown in FIG. 4 above. As shown in FIG. 4, control software (L1) 200 is coupled to RF driver software 205 which incorporates a Newton iteration algorithm 207 that in turn provides a predetermined number of bits N′ (e.g., 13 bits as shown in FIG. 4) to pre-distortion logic/software 209, which then generates a digital control word N in accordance with EQ. A.

$$N = \frac{- {K}_{1}}{{N}^{‵} - {K}_{2}} - {K}_{3} \qquad [ EQ . A ]$$

The digital control word N is in turn provided to a transceiver 210, which includes a non-volatile memory 215 such as a non-volatile random access memory. As shown, a predetermined number of digital control bits (e.g., 7 in the embodiment of FIG. 4) is provided from non-volatile memory 215 to a DCXO 220. As described above, these bits may correspond to the CDAC settings, while the fine tuning provided by digital control word N is provided to a CAFC register. Based on these control values, which thus select an amount of capacitance to be coupled into the oscillator, DCXO 220 generates a frequency f.

The L1 software 200 averages FCCH bursts and generates a frequency error output signal. The RF driver software 205 then updates the value of N to fine tune the DCXO to the desired frequency. The coarse tuning/calibration of the DCXO 220 is performed during IC manufacture and is stored as a 7 bit word in the transceiver chip. This stored CDAC setting centers the DCXO frequency to take out IC fabrication errors so that a nominal crystal and PCB board will yield the correct frequency. However, once the transceiver 210 is tested in the handset and during normal usage, the DCXO 220 will be tuned with the fine control capacitor array to remove the frequency errors due to crystal variations, PCB capacitance errors and temperature and aging effects.

The RF driver software 205 utilizes a Newton-Raphson iteration algorithm, which in some implementations may be a Secant form of the algorithm as described below, to drive the frequency error reported by the L1 software 200 to under ±0.3 PPM. Although the Newton-Raphson iteration will converge for well behaved nonlinear functions, convergence is faster if the function is linear. Since the AFC fine capacitor array has a nonlinear relationship between N and the DCXO output frequency, a linearization block (e.g., pre-distortion logic/software 209) is inserted so that the relationship between N′ and the output frequency is linearized. Ideally, this pre-distortion calculation is placed in the RF driver software 205; alternatively, it can be realized with digital logic on transceiver 210. The form of the pre-distortion equation [EQ. A] is set forth above.

At a given iteration in the Newton method, the value of the function is required as well as the derivative of the function. At the first iteration in the handset factory calibration, the derivative is simply the nominal value, [AFC_SLOPE], stored in NVRAM 215. At the second iteration, there are now two frequency error measurements and two N′ settings, so by using the Secant method (a specific form of Newton Raphson) we have a good estimate of the derivative of this particular DCXO, PCB and crystal combination. Since the N′ to frequency function is ideally linear, convergence to the desired frequency is possible in this second step, in theory to arbitrary accuracy. In practice, the final frequency accuracy is limited by the AFC's differential nonlinearity (DNL) and the degree to which the N′ to frequency curve is linearized. Note that linearization is imperfect since the K1, K2, K3 values in the above Equation A are based on all nominal parameters.

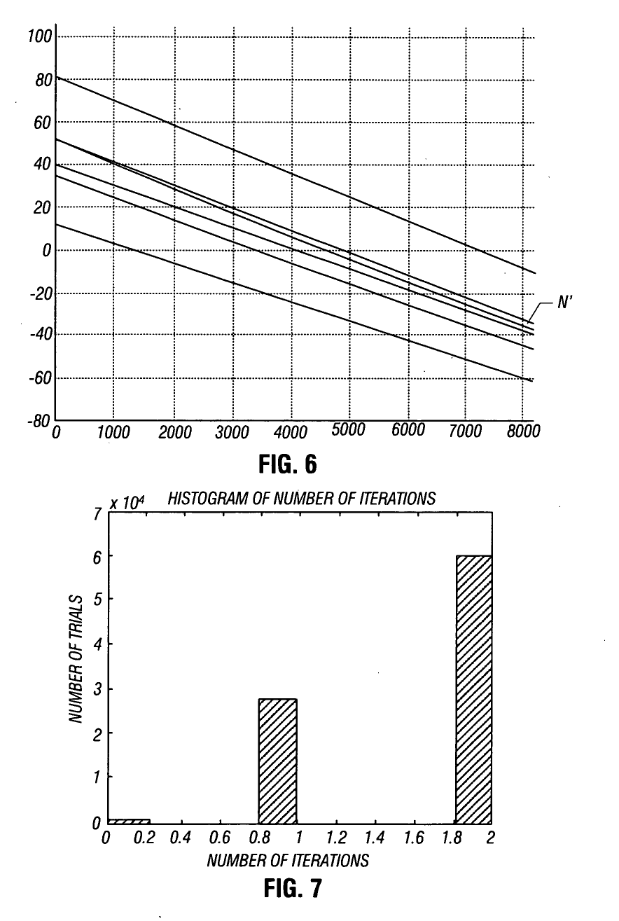

FIG. 5 below plots the frequency error of the DCXO versus N. The line indicated with one “N” is shown for all nominal parameters, while the remaining lines represent some random variations in the components. The frequency error versus N′ is shown in FIG. 6; again the line indicated with one “N′” is for nominal conditions. Note that the linearization algorithm was designed to have the frequency error equal when N=N′=0 and N=N′=8192.

The global variables, [cdacValue], [afcDacValue], [ferror] and [afcDacSlope] are initialized with the corresponding contents of the NVRAM 215. The NVRAM 215 is filled with preset values. Once these values are filled from the NVRAM 215, these values may be stored at a non-volatile memory location that can be accessed by the RF driver on a burst by burst basis. Also, the RF Driver software 205 should be able to write to these memory locations.

Frequency errors (up to +−30 PPM) are sent to RF driver software 205. RF driver software 205 decides how many linear steps to change in the frequency control setting by using the Newton iteration and the nominal value of afcDacSlope which was read from the NVRAM 215. The software pre-distorts these linear steps to the nonlinear steps of the CAFC capacitor array. The RF driver 205 writes the updated N value to the transceiver 210.

A new (reduced) frequency error from L1 software 200 is received.

RF driver software 250 uses current and past frequency errors and the change in the linear steps to compute the actual slope in the linearized frequency control. The value of afcDacSlope is updated with the actual slope, as opposed to the nominal slope that was stored in NVRAM 215.

The Newton iteration is applied again and the number of linear steps (N′ variable) to eliminate the frequency error are computed and then predistorted (N variable) to the actual value driving the CAFC capacitor array. The final value of N is written to the transceiver 210.

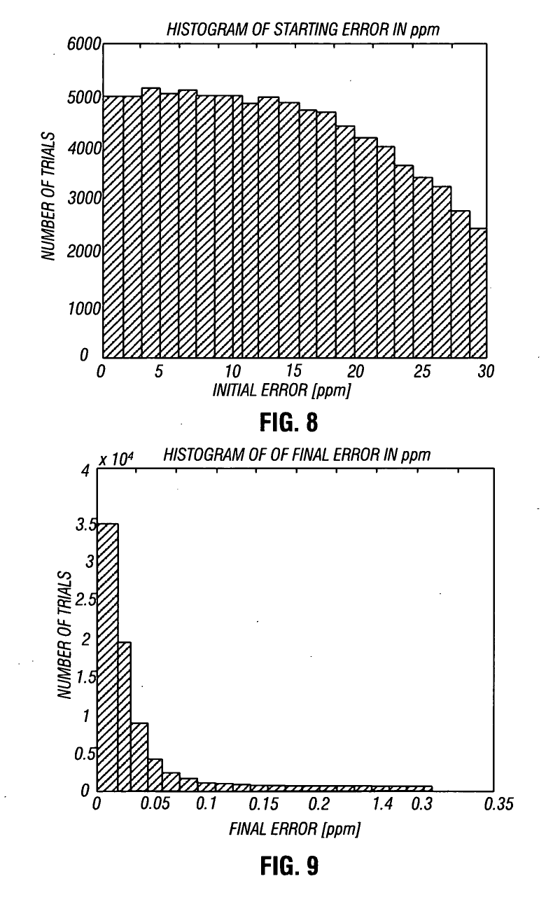

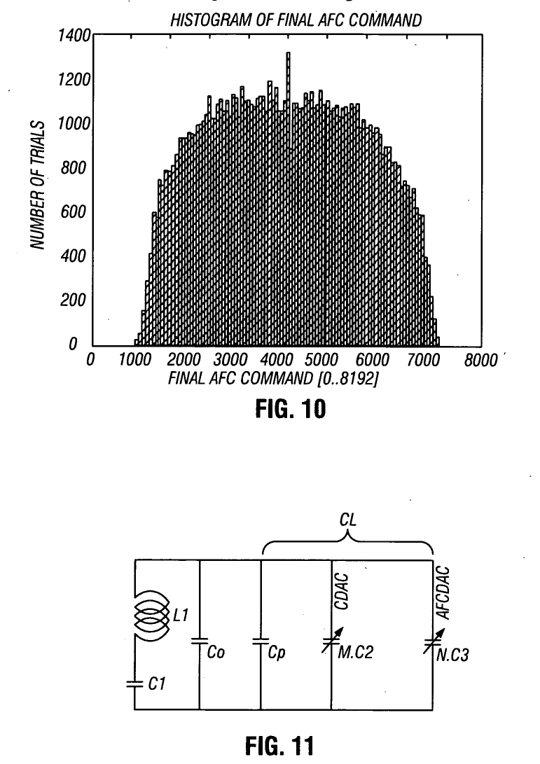

Simulations over 100K trials (where random errors in crystal parameters, PCB capacitance, etc., were implemented) show that errors up to +/−30 PPM can all be corrected to within ±0.3 PPM in two steps. All random variables were uniformly distributed over the ranges shown below. The histogram in FIG. 7 indicates that the majority of the errors need two full iterations to converge; however, a large percentage only require a single iteration. FIG. 8 in turn shows a histogram of initial frequency errors (i.e., prior to CAFC tuning). FIG. 9 indicates that all errors are reduced to under 0.3 PPM in 2 steps. Finally, FIG. 10 indicates that the CAFC settings are well centered, with margin on the top and bottom ends for further adjustment.

Assumptions:

Crystal+/−10 PPM

C1+/−15%

C0+/−10%

CAFC array DNL<=0.5 LSB (random)

CAFC array total capacitance+/−5%

In one implementation, a DCXO is made of a Pierce crystal oscillator. The frequency of the crystal oscillator is adjusted by adding capacitance in parallel with the crystal. The change in amount of parallel capacitance results in pulling the frequency of the crystal oscillator. The caps are selected digitally, thus we call the crystal-oscillator a “Digital-Control Crystal Oscillator” (DCXO).

There are two capacitor digital-to-analog connectors (DACs) that exist in the DCXO. The first capacitor DAC is called CDAC which is a coarse DAC used in factory calibration to center the frequency of the DCXO. The second capacitor DAC is called AFC DAC, which is used for accurate frequency tracking of the DCXO. The AFC DAC is used to compensate for aging, temperature change, Doppler Effect and offset of CDAC.

FIG. 11 shows a basic resonator model for DCXO. Capacitor C1, inductor L1 (not to be confused with L1 software), and capacitor Co represents a simplified model of the crystal oscillator. Capacitor Cp is the parasitic capacitor due to pad and PCB routing. The term M.C2 represents CDAC which is the coarse DAC and M represents the input to the coarse DAC. The term N.C3 is modeling the fine DAC which is used for tuning DCXO in normal operation. As one example, Mε{0,127} and capacitor C2 is about 4 pF/128. For AFC DAC we have Nε{0,8191} where capacitor C3 is about 2 pF/8192. And Cp is about 5 pF.

### Derivation of Algorithm to Create a Linear DCXO:

The output frequency of the DCXO can be written as:

$$fo ( CL ) = \frac{1}{2 \cdot π} \cdot \frac{1}{\sqrt{L 1 \cdot C 1}} \cdot \sqrt{1 + \frac{C 1}{Co + CL}} \qquad EQ ( 1 )$$

where the term

$$fs = \frac{1}{2 \cdot π} \cdot \frac{1}{\sqrt{L 1 \cdot C 1}} \qquad EQ ( 2 )$$

is called the “series resonate frequency of the crystal oscillator”. We adjust the resonate frequency of the crystal oscillator through adjusting CL. To linearize fo(CL) we start with series expansion of:

$$\sqrt{1 + x} = 1 + \frac{1}{2} \cdot x - \frac{1}{8} \cdot {x}^{2} + O ( {x}^{3} ) \qquad EQ ( 3 )$$

### Where x is:

$$x = \frac{C 1}{Co + CL} \qquad EQ ( 4 )$$

Thus an approximation to fo(CL) is:

$$fo ( CL ) = fs \cdot ( 1 + \frac{1}{2} \cdot x - \frac{1}{8} \cdot {x}^{2} ) = fs \cdot y \qquad EQ ( 5 )$$

To check how good the above approximation is let's use typical values for a crystal oscillator:

C1=3.557 fF fs=26 MHz L1=10.5 mH Co=988.7 fF CL=(4 pF . . . 12 pF)

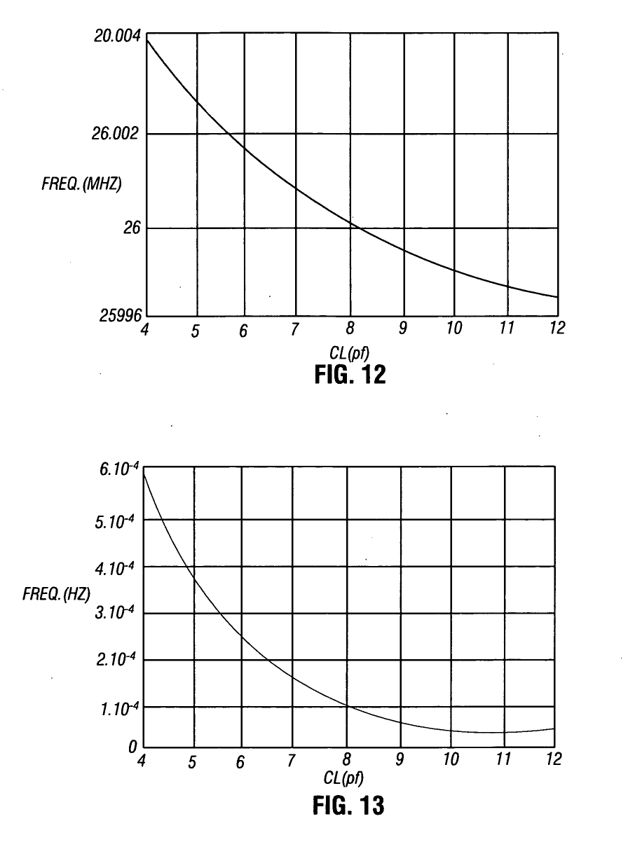

FIG. 12 shows a plot of fo(CL) using both exact and approximated equations. The x-axis is CL in pF and the y-axis is the frequency in MHz. The solid line represents the exact value fo(CL) using Eq(1) and the dots are an estimate of fo(CL) using Eq(5). The error between exact and approximated estimate of CL is shown in FIG. 13. In this plot, y-axis is the frequency in Hz. As we can see the error is much less that 0.1 ppm. Equation (5) is linear in terms of y but not x. So we solve x for a given y. Due to quadratic form of equation we have two solutions to the problem:

x=2·(1+\sqrt{3−2·y}) EQ(6)

and

x=2·(1−\sqrt{e−2·y}) EQ(7)

Since CL is much larger than C1, then EQ(6) cannot provide a valid solution for CL. Thus we used EQ(7) as a solution for CL. Next, we can determine CL in terms of y as follows:

$$CL ( y ) = \frac{C 1}{2} \cdot \frac{1}{1 - \sqrt{3 - 2 \cdot y}} - Co \qquad EQ ( 8 )$$

We are interested in CL as a function of change in y. Thus, let y be:

y=1+α EQ(9)

then CL in terms of α is:

$$CL ( α ) = \frac{C 1}{2} \cdot \frac{1}{1 - \sqrt{1 - 2 \cdot α}} - Co \qquad EQ ( 10 )$$

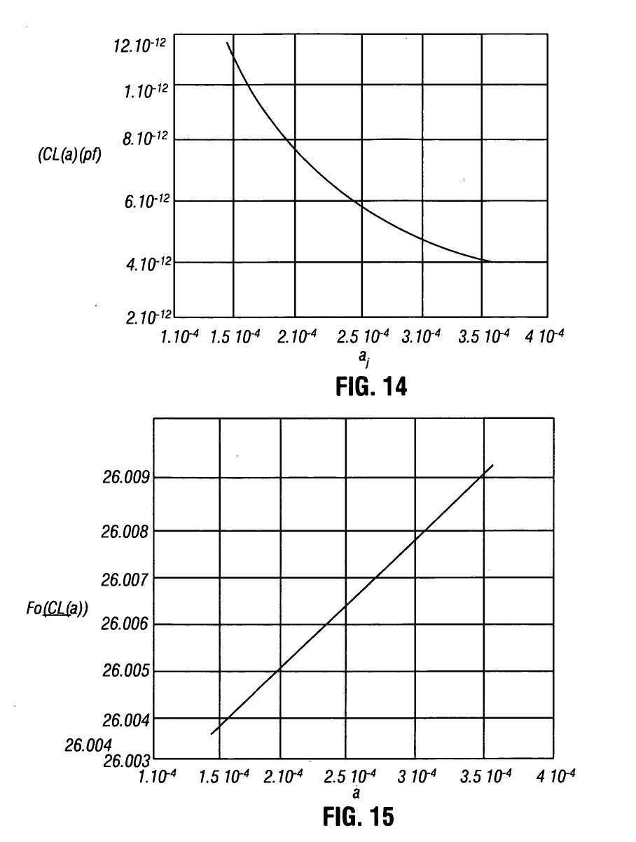

FIG. 14 shows a plot of CL as a function of α. Again the y axis in this plot is in pF and x axis corresponds to α value. The curvature of CL as a function of a corrects for nonlinear curve of EQ(1).

A plot of fo as function of α is shown in FIG. 15. As one can see, the frequency change of DCXO as a function of α is linear.

The problem with EQ(10) is that we are using square-root function which is an expensive function to be implemented in digital. Next we use Taylor expansion based on variable a:

$$CL ( α ) = \frac{C 1}{2} \cdot ( \frac{1}{α} - \frac{1}{2} ) - Co = \frac{C 1}{2} \cdot \frac{1}{α} - ( Co + \frac{C 1}{4} ) \qquad EQ ( 11 )$$

In the above equation C1/4 is much less than Co and hence it can be ignored.
A comparison of approximation to CL versus exact calculation of CL is shown in FIG. 16.
Next we need to decompose CL in terms of code at input of the AFC-DAC.

### Let CL be

CL=CLₘ+M·ΔCL_{M}+N·ΔCL_{N} EQ(12)

where CLm is the minimum value of CL, ΔCL_{M} is the LSB capacitor value of the coarse DAC (CDAC), and ΔCL_{N} is the LSB capacitor value of the fine DAC (AFC DAC). Then by combining EQ(11) and EQ(12) we get

$$N = \frac{1}{2} \cdot \frac{C 1}{Δ {CL}_{N}} \cdot \frac{1}{α} - \frac{Co + CLm + M \cdot Δ {CL}_{M}}{Δ {CL}_{N}} \qquad EQ ( 13 )$$

In the above equation, for reasonable N value, a will have an offset. Thus we modify the above equation into:

$$N = \frac{1}{2} \cdot \frac{C 1}{Δ {CL}_{N}} \cdot \frac{1}{{α}_{0} + Δ α} - \frac{Co + CLm + M \cdot Δ {CL}_{M}}{Δ {CL}_{N}} \qquad EQ ( 14 )$$

Where α₀ is the offset of α, and Δα represents variation in α. The above equation is not suitable for digital implementation since it needs floating point operation. Next we use a scale factor K to convert EQ(14) into an integer operation as shown in EQ. (15).

$$N = \frac{C 1 \cdot K}{2 \cdot Δ {CL}_{N}} \cdot \frac{1}{K \cdot {α}_{0} - K \cdot Δ α} - \frac{Co - CLm - M \cdot Δ {CL}_{M}}{Δ {CL}_{N}} \qquad EQ ( 15 )$$

An example of equation for calculating N is given below. In this example we assume that the crystal oscillator has the following parameters:

CLₘ=5 pF C_{dac}=4 pF C_{afc}=2 pF C1=3.53 fF L1=1.06187 mH Co=1.02 pF

Then we have:

$$Δ {CL}_{M} = \frac{Cdac}{127} = 31.496 fF$$

$$Δ {CL}_{N} = \frac{Cafc}{8191} = 244.17 aF$$

From EQ(11) we know that

$$α = \frac{1}{2} \cdot \frac{C 1}{CL + Co}$$

For minimum CL and maximum CL we have:

α_{CL=8.98 pf}=1.764094231109319613210⁻⁴ α_{CL=6.98 pf}=2.204834917657541860110⁻⁴

Thus, we can write:

α₀=1.7640942311110⁻⁴ Δα=0 . . . 4.40740687×10⁻⁵

Lets assume that we want Δα to be in range of (0,8191), then K must be

$$K = \frac{8191}{Δ α} = 1.858462413 \times {10}^{8}$$

The terms in EQ(15) assuming M=63 are

$$\frac{C 1}{Δ {CL}_{N}} \cdot \frac{K}{2} = 1343400241$$

$$\frac{Co + CLm + M \cdot Δ {CL}_{M}}{Δ {CL}_{N}} = 32781$$

$${α}_{0} \cdot K = 32785$$

Using the above values we obtain an expression for N, the input to AFC DAC, and input to algorithm, N′.

$$N = \frac{1343400241}{32785 + {N}^{′}} - 32785 \qquad EQ ( 16 )$$

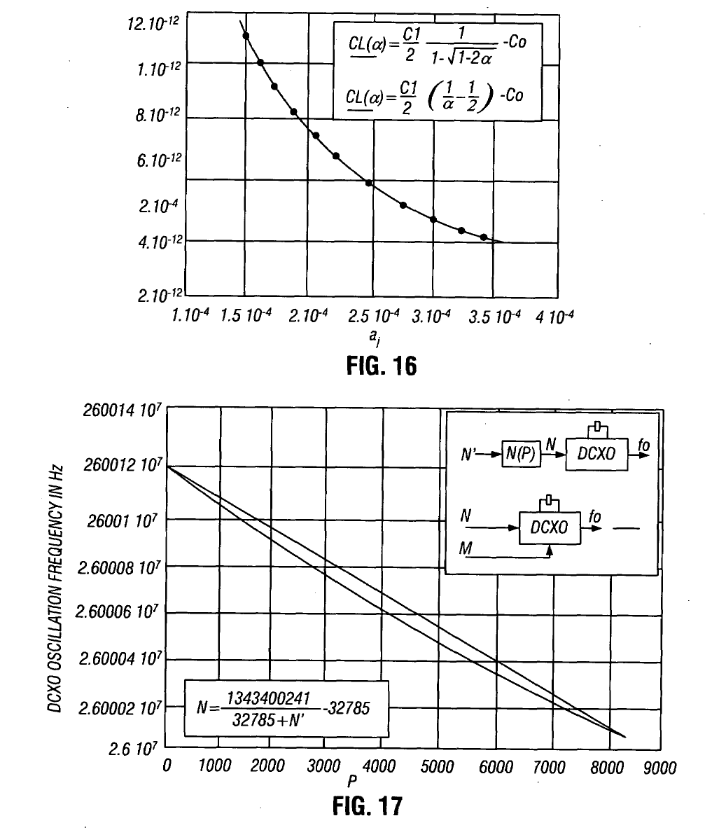

FIG. 17 shows the DCXO frequency as a function of input code with and without linearization correction logic.

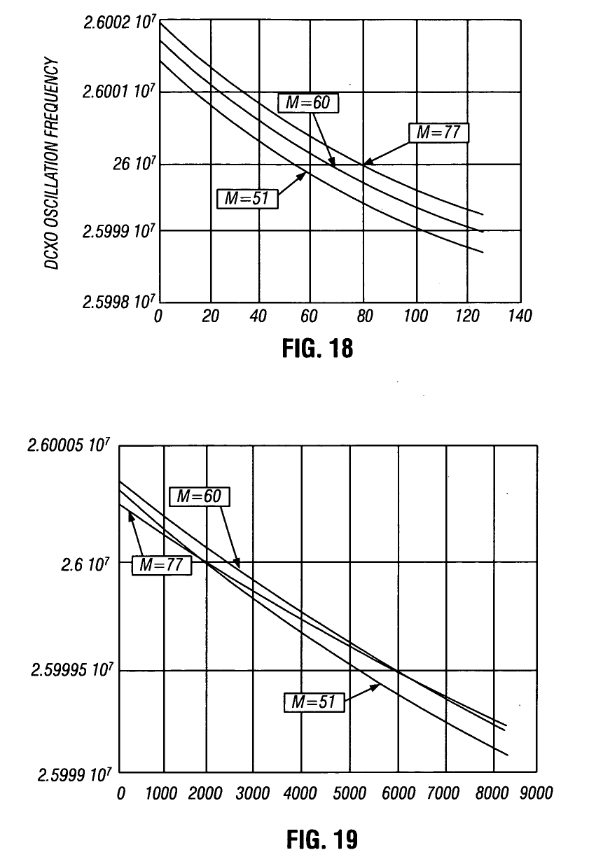

As long as M is correcting for Co and CLm of EQ. 15, the crystal oscillator will remain linear in frequency. However, let's assume C1 of the crystal oscillator changes due to process variation. Then M has to change in order to compensate for variation of C1. An example of C1 impact on the frequency of the crystal oscillator is shown in FIG. 18. In this figure the variation in C1 causes factory calibration to choose a different M value to center the frequency of the crystal oscillator. We assume that EQ. 15 was calculated for nominal case and we did not change the constant in the equation to compensate for change in M value. An example of crystal oscillator with different C1 is shown in FIG. 18. As one can see, different M value should be used in factory calibration to compensate for change in center frequency of the crystal oscillator.

Assume that we are still using EQ. 16, then, the output of the DCXO will show different slopes as shown in FIG. 19.

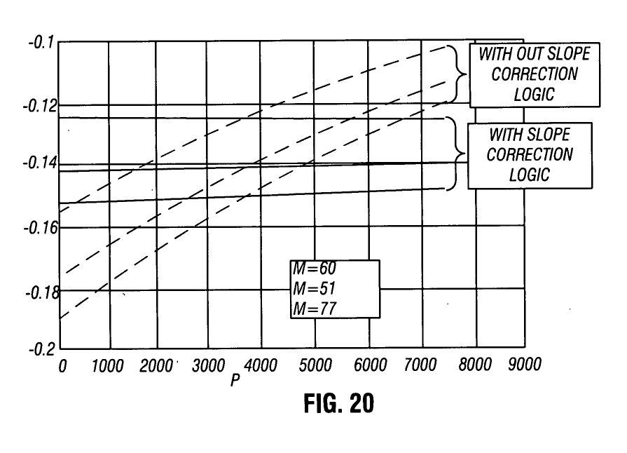

FIG. 20 shows the slope of the DCXO as a function of input N′ and output frequency of the DCXO. Dashed lines are corresponding to DCXO with no linearity correction logic. The solid lines correspond to frequency change with slope correction logic. The y-axis represents the slope of the derivative of the DCXO frequency. The x-axis represents the input to DCXO.

Slope correction logic can be implemented to reduce the slope variation but such correction logic can be expensive, difficult to implement and require additional factory calibration. The preferred method is the embodiment here that uses the Secant method which dynamically computes the slope after the first N′ update.

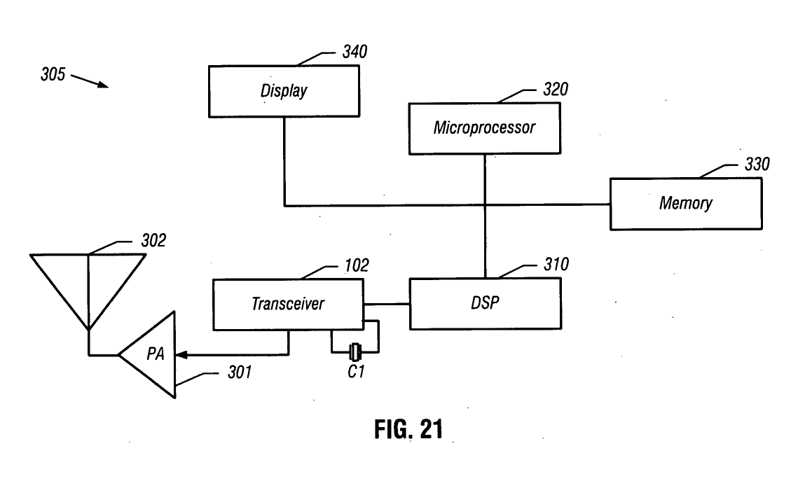

A transceiver in accordance with an embodiment of the present invention can be implemented in many different systems. As one example, referring now to FIG. 21, shown is a block diagram of a system in accordance with an embodiment of the present invention. As shown in FIG. 21, system 305 may be a cellular telephone handset, although the scope of the present invention is not so limited. For example, in other embodiments, the system may be a pager, personal digital assistant (PDA) or other such device. As shown, an antenna 302 may be coupled via a PA 301 to a transceiver 102, which may correspond to transceiver 210 of FIG. 4. In turn, transceiver 102 may be coupled to a digital signal processor (DSP) 310, which may handle processing of baseband communication signals, and may include hardware, software, firmware or combinations thereof to generate a control signal for controlling a fine frequency for a DCXO of transceiver 102. Note that transceiver 102 is also coupled to an external crystal C1 that provides a clock frequency for use by the DCXO of transceiver 102. In turn, DSP 310 may be coupled to a microprocessor 320, such as a central processing unit (CPU) that may be used to control operation of system 305 and further handle processing of application programs, such as personal information management (PIM) programs, email programs, downloaded games, and the like. Microprocessor 320 and DSP 310 may also be coupled to a memory 330. Memory 330 may include different memory components, such as a flash memory and a read only memory (ROM), although the scope of the present invention is not so limited. Furthermore, as shown in FIG. 21, a display 340 may be present to provide display of information associated with telephone calls and application programs. Although the description makes reference to specific components of system 305, it is contemplated that numerous modifications and variations of the described and illustrated embodiments may be possible. Furthermore, transceiver 102 and/or DSP 310 may include an article in the form of a machine-readable storage medium (or may be coupled to such an article, e.g., memory 330) onto which there are stored instructions and data that form software program(s). The software program(s) may include L1 software 200 and RF driver software 250 to provide for control of transceiver 102, e.g., for automatic frequency controlling generation of a reference frequency in transceiver 102.

Thus embodiments may greatly reduce the number of iterations required to converge to a low error level. If the original nonlinearity of the curve is exactly known, an algorithm in accordance with an embodiment of the present invention will guarantee that one can converge to arbitrary accuracy within 2 iterations. However, in practice the linearization process is not perfect and as such achieving full convergence within two iterations can be dependent on the initial error (e.g., ±30 PPM) and final accuracy required (e.g., under ±0.3 PPM).

While described herein as being applied to a system for cell phones, embodiments can be implemented in a wide range of systems, even outside the wireless arena. Further, although described in an implementation of tuning capacitors to change the frequency, other types of oscillators can be tuned by switching in binary weighted current sources or other controllable elements. For example, if the basic current to frequency characteristic of such current sources was monotonic but nonlinear, an algorithm in accordance with an embodiment of the present invention could be applied to such an oscillator.

In fact, the output variable does not even have to be frequency. Consider any analog output value (current, voltage, frequency, temperature, etc.) that has a nonlinear but monotonic relationship with a digital input control. The algorithm of linearization and the Newton (Secant) method can be used to converge to the desired output level in a relatively small number of iterations.

Attached hereto as Appendix A is example code for correcting slope to obtain a linear frequency characteristic, while Appendix B attached hereto is a theoretical background for and proof of an algorithm in accordance with an embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

Appendix A:

/***********************************************************************
Example code to correct slope of DCXO so that frequency
*response of DCXO is linear.
************************************************************************

| | |
|---|---|
| ** | DESCRIPTION: |

| | |
|---|---|
| * | 0X50148020 |

| | |
|---|---|
| * | -------------- - 0X8012 |

| | |
|---|---|
| * | 0X8013 + k |

*
************************************************************************/
module aux_dcxo_sc(clk,rst,st0,k,z,done,cnt0);

| input | | clk; | // input clock to the block |
|---|---|---|---|
| input | | rst; | // reset pin active high |
| input | | st0; | // start signal |
| input | [15:0] | k; | // input to control DCXO frequency |
| output | [15:0] | z; | // To afc DAC |

| | | |
|---|---|---|
| output | done; | // Signal back to serial port that we are done |

// with conversion process

output [ 4:0] cnt0;

| | | |
|---|---|---|
| \grave{ }define | DIVIDEND | 34′h050148020 |
| \grave{ }define | OFFSET1 | 16′h8013 |
| \grave{ }define | OFFSET2 | 16′h8012 |

| reg | | st1; | |
|---|---|---|---|
| reg | | st2; | |
| reg | | done; | |
| reg | [17:0] | a; | |
| reg | [ 4:0] | state; | |
| wire | [17:0] | divisor = \grave{ }OFFSET1 + k; | |
| wire | [33:0] | dividend= \grave{ }DIVIDEND; | |
| reg | [15:0] | quotient; | |
| reg | [15:0] | quotient_latch; | |
| wire | [15:0] | r | = dividend[15:0]; |

| | | |
|---|---|---|
| wire | [ 4:0] | cnt0; |

| | |
|---|---|
| assign | z = quotient − \grave{ }OFFSET2; |

aux_dcxo_counter counter(clk,rst,st1,cnt0);
// retime the start signal with local clock
always @ (posedge clk) st1 <= st0;
always @ (posedge clk) st2 <= st1;
// main algorithm for calculating afc code
always @ (posedge clk)

begin
if(st2 == 1′b0)

begin

| | |
|---|---|
| quotient | <= 16′h0000; |

| | |
|---|---|
| a | <= dividend >> 16; |

| | |
|---|---|
| state | <= 5′b00000; |

end

else

begin

if(state < 17)

if(a >= divisor)

begin

| | |
|---|---|
| a | <= ((a − divisor) << 1) + r[5′h0f-state]; |
| quotient | <= (quotient << 1) + 1′b1; |

end

else

begin

| | |
|---|---|
| a | <= ((a − 0) << 1) + r[5′h0f-state]; |
| quotient | <= (quotient << 1) + 1′b0; |

end

if(state < 18) state <= state + 5′b00001;
end

end

always @ (posedge clk)

| | |
|---|---|
| if(state == 18) | done <= 1′b1; |
| else | done <= 1′b0; |

endmodule

| | |
|---|---|
| module | aux_dcxo_counter(clk,rst,st,cnt); |
| input | clk; |
| input | rst; |
| input | st ; |
| output | [4:0] cnt; |
| reg | [4:0] cnt; |

always @ (negedge rst or posedge clk)

| | |
|---|---|
| if(rst == 1′b0) | cnt <= 5′b00000; |
| else | |

| | |
|---|---|
| if(st == 1′b0) | cnt <= 5′b00000; |
| else | |

| | |
|---|---|
| if(cnt < 18) | cnt <= cnt + 5′b00001; |

endmodule

### APPENDIX B

### AFC Algorithm

Two step approach:
1. Linearize
2. Perform (modified) Newton's iteration on the linearized variable

### Theory:

$$f = {f}_{0} \sqrt{1 + \frac{{C}_{1}}{( {C}_{0} + {C}_{LM} ) + N \cdot Δ C}}$$

where C_{O}+C_{LM} is fixed, let us call this C_{A}

$$= {f}_{o} \sqrt{1 + \frac{{C}_{1}}{{C}_{A} + N \cdot Δ C}}$$

where N is output to AFC/DAC and AC is capacitance step size
Can we create a variable, say, N′, such that N=g(N′) and frequency, f, is linear with respect to N′?
i.e.:

$${\to }_{{N}^{′}} g ( {N}^{′} ) {\to }_{N} cap {array}^{frequency} {\to }_{f} \\ and$$

$$\frac{d f}{d {N}^{′}} is a constant . \\ \frac{d f}{d {N}^{′}} = \frac{d f}{d N} \cdot \frac{d N}{d {N}^{′}} = - {f}_{o} \cdot \frac{1}{2 \sqrt{1 + \frac{{C}_{1}}{{C}_{A} + N Δ C}}} \cdot \frac{{C}_{1} Δ C}{{( {C}_{A} + N Δ C )}^{2}} \cdot \frac{d N}{d {N}^{′}}$$

As an approximation, let us assume C₁<<C_{A}+NΔC. Thus

$$\sqrt{1 + \frac{{C}_{1}}{{C}_{A} + N Δ C}} \approx 1.$$

### Therefore, if

$$\frac{d N}{d {N}^{′}} α 1 / \frac{1}{{( {C}_{A} + N Δ C )}^{2}} ,$$

then we are done.

### Let

$${K}_{1} \cdot \frac{d N}{d {N}^{′}} = {( {C}_{A} + N Δ C )}^{2}$$

Where K₁ is a constant of our choice.

$$∴ {dN}^{′} = {K}_{1} \cdot \frac{dN}{{( {C}_{A} + N Δ C )}^{2}}$$

$$or$$

$${dN}^{′} = ( {K}_{1} / Δ C ) \cdot \frac{d ( N Δ C )}{{( {C}_{A} + N Δ C )}^{2}} \\ ∴ {N}^{′} = - ( {K}_{1} / Δ C ) \cdot \frac{1}{{C}_{A} + N Δ C} \cdot + {K}_{2}$$

Where K₂ is another constant of our choice.

$${N}^{′} = - \frac{{K}_{1} / Δ C}{{C}_{A} + N \cdot Δ C} + {K}_{2} \qquad [ 1 ]$$

Rearranging terms, we can evaluate N=g(N′)→

$$N = - \frac{{K}_{i} / Δ {C}^{2}}{{N}^{′} - {K}_{2}} - {C}_{A} / Δ C \qquad [ 2 ]$$

Going back to df/dN′,

$$\frac{d f}{d {N}^{′}} \approx - \frac{{f}_{0}}{2} \cdot \frac{{C}_{1} Δ C}{{( {C}_{A} + N Δ C )}^{2} } \cdot \frac{d N}{d {N}^{′}} = - \frac{{f}_{0}}{2} \cdot \frac{{C}_{1} Δ C}{{K}_{1}} \qquad [ 3 ]$$

How do we choose K₁, K₂?

Nε[0,N′ₘₐₓ]

If we allow N′ε[0,N′ₘₐₓ]
and a one-to-one mapping between N′ and N, we will be able to compute K₁ and K₂.

### Le N=0 for N′=0 and N=Nₘₐₓ for N′=Nₘₐₓ

Then from [1],

$${K}_{2} - \frac{{K}_{1} / Δ C}{{C}_{A}} = o$$

$$and$$

$${K}_{2} - \frac{{K}_{1} / Δ C}{{C}_{A} + {N}_{max} Δ C} = {N}_{max}^{′}$$

### Solving for K₁, K₂:

$${K}_{1} = \frac{{N}_{max}^{′} \cdot Δ C}{1 / {C}_{A} - 1 / ( {C}_{A} + {N}_{max} Δ C )}$$

$$and {K}_{2} = \frac{{K}_{1}}{{C}_{A} \cdot Δ C}$$

Note, the above choices of K₁ and K₂ will only ensure that N′ has a wide range for a wide range of N. It will not affect the linearity of f as a function of N′.
Now that we have a variable N′ such that f is linear (more or less linear, even with variations in parameters. As parameters vary, the linearity will decrease. But still, at heart, the function is linear.) with N′, we do Newton iterations.
Let P α(f_{target}−f) be the input to the transceiver from the baseband processor. We know the value of K such that P=K·(f_{target}−f).

$$So \frac{d P}{d f} = - K$$

### Therefore,

$$\frac{d P}{d {N}^{′}} = \frac{d P}{d f} \cdot \frac{d f}{d {N}^{′}} = k \cdot \frac{{f}_{0}}{2} \cdot \frac{{C}_{1} Δ C}{{K}_{1}}$$

Thus the final two-step algorithm is as follows, where all terms in [ ] denote pre-computed values:
1. Set initial values of N′, N.

$${N}^{′} ← {N}_{1}^{′} , N ← - \frac{[ {K}_{1} / Δ {C}^{2} ]}{{N}_{1}^{′} - {K}_{2}} - [ {C}_{A} / Δ C ]$$

2. Wait for frequency update P←P₁

$$3. {N}_{2}^{′} = {N}_{1}^{′} - {P}_{1} [ \frac{2 {K}_{1}}{{Kf}_{0} {C}_{1} Δ C} ]$$

$$4. {N}_{2} = - \frac{[ {K}_{1} / Δ {C}^{2} ]}{{N}_{2}^{′} - {K}_{2}} - [ {C}_{A} / Δ C ]$$

5. Wait for frequency update P←P₂
6. Compute the real slope,

$$\frac{d P}{d {N}^{′}} ,$$

instead of using the pre-computed value. Then do the Newton iteration.

$${N}_{3}^{′} = {N}_{2}^{′} - {P}_{2} \cdot \frac{{N}_{2}^{′} - {N}_{1}^{′}}{{P}_{2} - {P}_{1}}$$

$$7. {N}_{3} = - \frac{[ {K}_{1} / Δ {C}^{2} ]}{{N}_{3}^{′} - {K}_{2}} - [ {C}_{A} / Δ C ]$$

This algorithm is expected to converge to within ±0.3 ppm after step 7. What are the conditions under which the AFC algorithm will converge (in two steps)?

### Formulation of Problem

If frequency as a function of N′ is perfectly linear, the algorithm will converge in two steps irrespective of what the scope is, to infinite precision.
So the only cases where the algorithm might not converge in two steps is when the frequency vs. N′ is non-linear.
How much non-linearity can we tolerate?
Frequency, f, is a function of N′. It is very linear, but not perfectly linear.

$$\frac{d f}{d {N}^{′}}$$

should be a constant. Ideally, when there is no variation of parameters,

$$\frac{d f}{d {N}^{′}}$$

will be a constant by design. However, with variations between real and nominal values of C₁, ΔC, C_{A}, etc.,

$$\frac{d f}{d {N}^{′}}$$

will no longer be a constant. What is the maximum

$$\vert \frac{{d}^{2} f}{d {N}^{′2}} \vert$$

that we can tolerate, such that the algorithm converges to within 0.3 ppm of the target frequency in two iterations?

$$P = K ( {f}_{t} - f )$$

$$\frac{d P}{d f} = - K : \frac{{d}^{2} P}{d {f}^{2}} = 0$$

$$\frac{{d}^{2} P}{d {N}^{′2}} = \frac{d f}{d {N}^{′}} \cdot \frac{{d}^{2} P}{d {N}^{′} d f} + \frac{d P}{d f} \cdot \frac{{d}^{2} f}{d {N}^{′} 2} = - K \cdot \frac{{d}^{2} f}{d {N}^{′2}}$$

So what is max

$$\frac{{d}^{2} P}{d {N}^{′2}} ?$$

Such that P₃<εₘₐₓ (P₃ should be 0 ideally, if all is perfect).

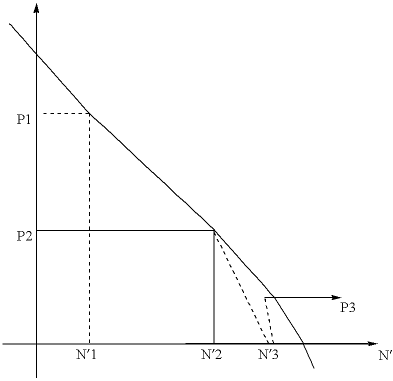

|P₃| has to be <εₘₐₓ

$${N}_{3}^{′} = {N}_{2}^{′} - {P}_{2} \cdot \frac{{N}_{2}^{′} - {N}_{1}^{′}}{{P}_{2} - {P}_{1}}$$

The slope, dP/dN′, at N′₁+N′₂/2 can be approximated as

$$\frac{{P}_{2} - {P}_{1}}{{N}_{2}^{′} - {N}_{1}^{′}}$$

[mean value theorem]

$$P a t \frac{{N}_{1}^{′} + {N}_{2}^{′}}{2}$$

can also be approximated as

$$\frac{{P}_{1} + {P}_{2}}{2} .$$

Now applying Taylor expansion for N′₃ around

$$\frac{{N}_{1}^{′} + {N}_{2}^{′}}{2} ,$$

$${P}_{3} = \frac{{P}_{1} + {P}_{2}}{2} + \frac{{P}_{2} - {P}_{1}}{{N}_{2}^{′} - {N}_{1}^{′}} ( {N}_{3}^{′} - \frac{{N}_{1}^{′} + {N}_{2}^{′}}{2} ) + \frac{{d}^{2} P}{d {N}^{′2}} \frac{{( {N}_{3} - \frac{{N}_{1}^{′} + {N}_{2}^{′}}{2} )}^{2}}{2} + …$$

Inserting the value of N′₃, i.e.,

$${N}_{3}^{′} = {N}_{2}^{′} - {P}_{2} \cdot \frac{{N}_{2}^{′} - {N}_{1}^{′}}{{P}_{2} - {P}_{1}} , \\ \begin{matrix}{P}_{3} = \frac{{P}_{1} + {P}_{2}}{2} + \frac{{P}_{2} - {P}_{1}}{{N}_{2}^{′} - {N}_{1}^{′}} \\ ( {N}_{2}^{′} - {P}_{2} \cdot \frac{{N}_{2}^{′} - {N}_{1}^{′}}{{P}_{2} - {P}_{1}} - \frac{{N}_{1}^{′} + {N}_{2}^{′}}{2} ) + \\ \frac{{d}^{2} P}{d {N}^{′2}} \frac{{( … )}^{2}}{2} + … \\ = {\frac{{P}_{1} + {P}_{2}}{2} + \frac{{P}_{2} - {P}_{1}}{{N}_{2}^{′} - {N}_{1}^{′}} ( \frac{( {N}_{2}^{′} - {N}_{1}^{′} ) ( {P}_{1} + {P}_{2} )}{2 ( {P}_{2} - {P}_{1} )} ) +}_{{}_{= 0}} \\ \frac{{d}^{2} P}{d {N}^{′2}} \cdot \frac{{( {N}_{2}^{′} - {N}_{1}^{′} )}^{2} {( {P}_{1} + {P}_{2} )}^{2}}{{( {P}_{2} - {P}_{1} )}^{2} \cdot 8} + \underbrace{…}\end{matrix}$$

, and ignoring higher order terms.

$$\frac{{d}^{2} P}{d {N}^{′2}} \cdot \frac{{( {N}_{2}^{′} - {N}_{1}^{′} )}^{2} {( {P}_{1} + {P}_{2} )}^{2}}{{( {P}_{2} - {P}_{1} )}^{2} \cdot 8}$$

The final value, P₃, is the error that remains after two steps.

$${P}_{3} \approx \frac{{d}^{2} P}{d {N}^{′2}} \cdot {( \frac{( {N}_{2}^{′} - {N}_{1}^{′} )}{( {P}_{2} - {P}_{1} )} )}^{2} \cdot \frac{{( {P}_{1} + {P}_{2} )}^{2}}{8}$$

$$So , \vert {P}_{3} \vert \leq {\vert \frac{{d}^{2} P}{d {N}^{′2}} \vert}_{max} \cdot / {\vert \frac{d P}{d {N}^{′}} \vert}_{min}^{2} \cdot \frac{{( {P}_{1} + {P}_{2} )}_{max}^{2}}{8}$$

$$I f {\vert \frac{{d}^{2} P}{d {N}^{′2}} \vert}_{max} / {\vert \frac{d P}{d {N}^{′}} \vert}_{min}^{2} \cdot \frac{{( {P}_{1} + {P}_{2} )}_{max}^{2}}{8} \leq ɛ , \\ then \vert {P}_{3} \vert \leq ɛ . \\ So , {\vert \frac{{d}^{2} P}{d {N}^{′2}} \vert}_{max} \leq \frac{ɛ \cdot {\vert \frac{d P}{d {N}^{′}} \vert}_{min}^{2} \cdot 8}{{\vert {P}_{1} + {P}_{2} \vert}_{max}^{2}}$$

$$\vert \frac{d P}{d {N}^{′}} \vert \approx \vert \frac{K}{{K}_{1}} \vert \cdot \frac{{f}_{0} {C}_{1} Δ C}{2}$$

Therefore, we can conclude that the algorithm will necessarily converge in two steps if:

$${\vert \frac{{d}^{2} P}{d {N}^{′2}} \vert}_{max} \leq \frac{2 ɛ \cdot {\vert \frac{K}{{K}_{1}} \vert}^{2} {f}_{0}^{2} {C}_{1}^{2} Δ {C}^{2}}{{\vert {P}_{1} + {P}_{2} \vert}_{max}^{2}}$$

Using some nominal values of 0.3 ppm, 26.0 MHz, and Pₘₐₓ=8192, this comes to the requirement:

$${\vert \frac{{d}^{2} P}{d {N}^{′2}} \vert}_{max} \leq 2.5 \times {10}^{- 5}$$

What is claimed is:

1. A method comprising:
receiving a frequency error value corresponding to an error of a reference clock; and
determining a control value for a capacitor array used to generate the reference clock within two iterations of an algorithm, wherein the control value enables generation of the reference clock within a predetermined tolerance to a nominal value for the reference clock.

2. The method of claim 1, wherein if the control value and the reference clock frequency have a substantially linearized relationship, the control value is determined in a number of maximum iterations exceeding but approaching two.

3. The method of claim 1, further comprising determining a linearized control value using the frequency error value, an initial linearized control value, and a predetermined slope value corresponding to frequency error values versus linearized control values.

4. The method of claim 3, further comprising determining the control value using the linearized control value.

5. The method of claim 1, wherein the algorithm corresponds to a Newton-Raphson iteration algorithm.

6. The method of claim 3, wherein the initial linearized control value corresponds to a substantially median level between a high level and a low level of the control value.

7. The method of claim 3, further comprising generating an initial control value for the control value by applying the initial linearized control value to a predetermined function and providing the initial control value to the capacitor array.

8. The method of claim 7, wherein the predetermined function is to predistort the initial linearized control value to linearize a relationship between the initial linearized control value and the reference clock frequency.

9. The method of claim 7, further comprising generating an updated control value from the linearized control value using the predetermined function and providing the updated control value to the capacitor array.

10. The method of claim 9, further comprising:
receiving an updated frequency error value corresponding to the reference clock error responsive to the updated control value;
determining an actual slope value based on the initial linearized control value, the linearized control value, the frequency error value and the updated frequency error value;
generating a second updated linearized control value based on the updated control value, the linearized control value, the updated frequency error value and the actual slope; and
generating the control value from the second updated linearized control value using the predetermined function.

11. The method of claim 10, further comprising controlling the capacitor array using the control value and controlling a second capacitor array using a control word stored in a non-volatile storage, wherein the capacitor array provides fine tuning and the second capacitor array provides coarse tuning.

12. A system comprising:
a transceiver to transmit and receive radio frequency (RF) signals, the transceiver including an oscillator to generate a reference signal, the oscillator including a first capacitor array and a second capacitor array; and
a baseband processor coupled to the transceiver, the baseband processor to provide a control word to the transceiver to control a frequency of the reference signal, wherein the baseband processor includes a pre-distortion logic to receive a linearized control value determined according to a Newton iteration algorithm and to generate the control word therefrom, wherein the pre-distortion logic is to apply the linearized control value to a predetermined function to predistort the linearized control value to linearize a relationship between the linearized control value and the reference signal frequency.

13. The system of claim 12, wherein the baseband processor is to determine a frequency error value corresponding to an error of the reference signal, and determine the linearized control value within two iterations of the Newton iteration algorithm if a linearized relationship exists between the control word and the reference signal frequency, otherwise the control word is determined in a number of iterations of the Newton iteration algorithm exceeding but approaching two, wherein the control word enables generation of the reference clock within a predetermined tolerance to a nominal value for the reference clock.

14. The system of claim 12, wherein the baseband processor is to determine the linearized control value using the frequency error value, an initial linearized control value, and a predetermined slope value corresponding to frequency error values versus linearized control values.

15. The system of claim 14, wherein the initial linearized control value corresponds to a substantially median level between a high level and a low level of the control value.

16. The system of claim 12, wherein the transceiver further comprises a non-volatile storage to store a coarse control value to control the first capacitor array, and the control word is to control the second capacitor array, wherein the second capacitor array is to provide fine frequency tuning of the reference signal.

17. The system of claim 12, wherein the baseband processor further includes instructions that enable the baseband processor to receive the reference signal from the transceiver and to generate the frequency error value therefrom.

18. The system of claim 12, wherein the predetermined function corresponds to
$$N = \frac{- {K}_{1}}{{N}^{′} - {K}_{2}} - {K}_{3} ,$$
wherein N′ is the linearized control value, N is the control word, and K1, K2, and K3 are predetermined constants.

19. An article comprising a machine-accessible storage medium including instructions that cause a system to:
receive an error value corresponding to an error of an output signal; and
determine a control value for a controllable element used to generate the output signal within two iterations of a Newton (Secant) algorithm, wherein the control value enables generation of the output signal within a predetermined tolerance to a nominal value for the control signal, wherein the output signal has a nonlinear but monotonic relationship with the control value.

20. The article of claim 19, further comprising instructions that when executed enable the system to determine a linearized control value using the error, an initial linearized control value, and a predetermined slope value corresponding to error values versus linearized control values, and determine the control value using the linearized control value.

21. The article of claim 20, further comprising instructions that when executed enable the system to generate an initial control value for the control value by application of the initial linearized control value to a predetermined function and provide the initial control value to the controllable element, the predetermined function to predistort the initial linearized control value to linearize a relationship between the initial linearized control value and the output signal.
